(19) United States
(12) Patent Application Publication
(10) Pub. No.: US 2022/0358840 A1
(43) Pub. Date: Nov. 10, 2022

(54) Motor Vehicle

(71) Applicant: Volkswagen Aktiengesellschaft, Wolfsburg (DE)

(72) Inventors: Robert Jan Wyszka, Hannover (DE); Daniel Morales Fernandez, Braunschweig (DE); Adrian Haar, Hannover (DE)

(73) Assignee: Volkswagen Aktiengesellschaft, Wolfsburg (DE)

(21) Appl. No.: 17/619,914

(22) PCT Filed: Jun. 5, 2020
(86) PCT No.: PCT/EP2020/065727

§ 371 Date: Dec. 16, 2021

(30) Foreign Application Priority Data
Jun. 17, 2019 (DE) 10 2019 208 788.4

(51) Int. Cl. G08G 1/14; B60W 50/14; H04W 4/46

(52) U.S. Cl. CPC G08G 1/143; B60W 50/14; H04W 4/46; B60W 2050/146; B60W 2556/65

(57) ABSTRACT

The invention relates to a motor vehicle having a positioning system for determining the position (and for example the orientation) of the motor vehicle, wherein the motor vehicle comprises a communication interface for reading in parking space information (via a wireless communication system), wherein the parking space information comprises the position of the parking space and for example the size of the parking space, wherein the motor vehicle comprises a tracking module for determining the position of the parking space in relation to the position (as well as for example the orientation) of the motor vehicle as well as an image generator for determining the position of a virtual image component on a transparent display (of the motor vehicle) depending on the position of the parking space in relation to the position (as well as for example the orientation) of the motor vehicle.

### CROSS-REFERENCE TO RELATED APPLICATIONS

This application claims priority to German Patent Application No. DE 10 2019 208 788.4, filed Jun. 17, 2019 with the German Patent and Trademark Office. The contents of the aforesaid Patent Application are incorporated herein for all purposes.

### TECHNICAL FIELD

The invention relates to a motor vehicle having a positioning system for determining the position and the orientation of the motor vehicle. The invention furthermore relates to a communication system with such a motor vehicle, as well as at least one additional motor vehicle.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

DE 10 2012 218 334 A1 discloses a method for finding a parking space for motor vehicles.

DE 10 2009 028 024 A1 discloses a parking guidance system.

DE 10 2004 018 204 A1 discloses a system for transmitting information about parking spaces.

### SUMMARY

A need exists to improve the finding of parking spaces. The need is addressed by the subject matter of the independent claims. Embodiments of the invention are described in the dependent claims, the following description, and the drawings.

### BRIEF DESCRIPTION OF THE DRAWINGS

FIG. 1 shows an exemplary embodiment a group of motor vehicles;

FIG. 2 shows the motor vehicle according to FIG. 1 of a sectional interior view;

FIG. 3 shows an exemplary operating device;

FIG. 4 shows an exemplary embodiment of a parking space display module;

FIG. 5 shows an exemplary embodiment of a parking recognition module;

FIG. 6 shows an exemplary embodiment of the AR-based identification of parking spaces; and

FIG. 7 shows another exemplary embodiment of the AR-based identification of parking spaces.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a motor vehicle is provided having a positioning system for determining the position (and for example the orientation) of the motor vehicle, wherein the motor vehicle comprises an interface for reading in parking space information (via a wireless communication system), wherein the parking space information comprises the position of the parking space and for example the size of the parking space, wherein the motor vehicle comprises a tracking module for determining the position of the parking space in relation to the position (as well as for example the orientation) of the motor vehicle as well as an image generator for determining the position of a virtual image component (characterizing the parking space) (in particular in the sense of augmented reality (AR)) on a transparent display (of the motor vehicle) depending on the position of the parking space in relation to the position (as well as for example the orientation) of the motor vehicle (and optionally the viewing direction of the driver). The term “augmented reality” is in particular defined as overlaying a real environment with a computer-generated environment, i.e., a virtual world. Augmented reality is therefore in particular a type of human/technology interaction that inserts information for the user into his field of vision and therefore expands his perception. According to de.wikipedia.org/wiki/Erweiterte_Realit % C3% A4t, augmented reality (AR for short) is understood to be the computer supported augmentation of the perception of reality.

This information may correspond to all human sensory modalities. Frequently however, augmented reality is only understood to mean the visual representation of information, i.e., the addition of images or videos, or a real environment with computer-generated additional information on virtual objects by means of inserting/overlaying. This also holds true in particular for the present disclosure.

In some embodiments, the transparent display is arranged in the windshield of the motor vehicle, or respectively integrated therein.

In some embodiments, the transparent display is arranged in data glasses, or respectively integrated therein, wherein the data glasses are data-linked to the motor vehicle.

In some embodiments, the motor vehicle comprises environmental sensors for detecting parking space information. Environmental sensors within the meaning of the teachings herein may for example comprise one or more cameras, or respectively one or more laser scanners, or respectively one or more lidar devices, or respectively one or more radar devices, or respectively consist thereof.

In some embodiments, the motor vehicle is designed to output detected parking space information via the interface.

The aforementioned need, in particular in conjunction with one or more of the aforementioned features, is also addressed by a communication system for a motor vehicle, wherein the communication system has an aforementioned motor vehicle, wherein the communication system moreover has at least one additional motor vehicle for providing the parking space information.

In some embodiments, the communication system comprises a wireless communication link directly (car-2-car) or indirectly (via a center) between the motor vehicle and the other motor vehicle for transmitting parking space information from the other motor vehicle to the motor vehicle (and/or to transmit parking space information from the motor vehicle to the other motor vehicle). Details on car-2-car communication may be found in particular in DE 10 2005 013 648 A1, which is incorporated herein by reference.

The aforementioned need is moreover addressed by a method for operating an aforementioned motor vehicle, or respectively a method for operating an aforementioned communication system.

A motor vehicle pursuant to the teachings herein is in particular a land vehicle that may be used individually in road traffic. Those motor vehicles are in particular not limited to land vehicles with internal combustion engines. A motor vehicle pursuant to this disclosure may also be understood to be a vehicle driven by a motor, for example a vehicle for 3D mobility as well.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

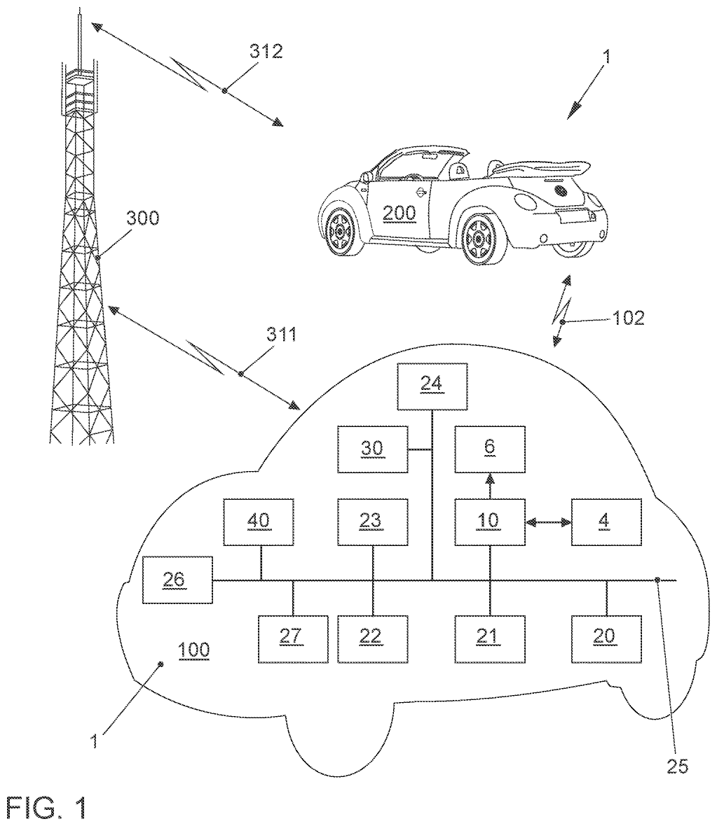

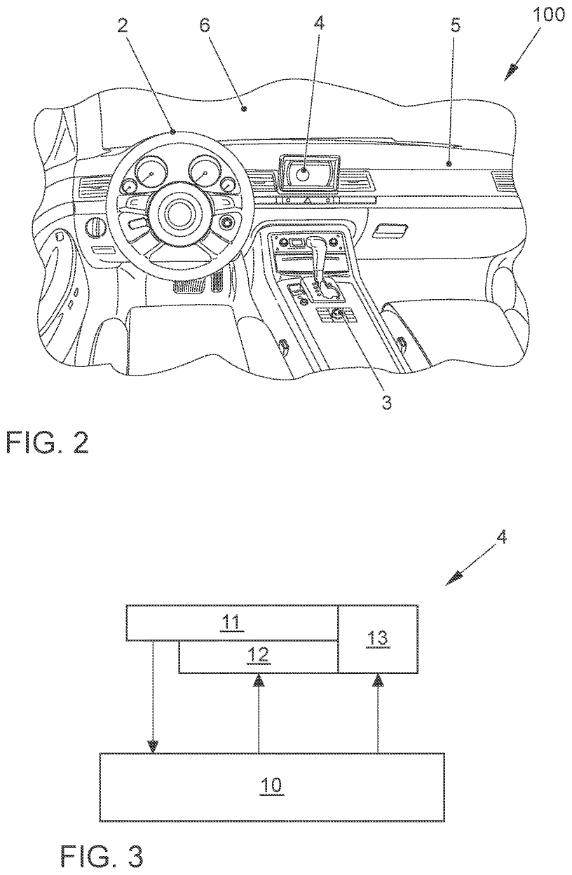

FIG. 1 shows a motor vehicle 100 as part of a group 1 of motor vehicles 100, 200 in a schematic diagram that is shown in FIG. 2 in a sectional interior view. The motor vehicle 100 comprises a control device 4 arranged in a dashboard 5 of the motor vehicle 100 in an exemplary embodiment. In an alternative or additional embodiment, such an operating device may however also be arranged in front of a steering wheel 2, in particular integrated in an instrument cluster. The operating device 4 comprises a display 12 shown in FIG. 3 for the changing depiction of information, above which a transparent touch screen 11 is arranged. It may be provided that the control device 4 also comprises an actuator 13 for generating haptic feedback. The control device 4 is coupled via a display control 10 to a bus system 25 and serves to operate an infotainment system 20, an automatic climate control system 21, a navigation system 22, a telephone 23 and a communication interface 24. To accomplish this, operating elements are shown on the display 12, wherein touching the touch screen 11 in the region of a depicted operating element causes a corresponding execution of a function of the motor vehicle 100 represented by the operating element.

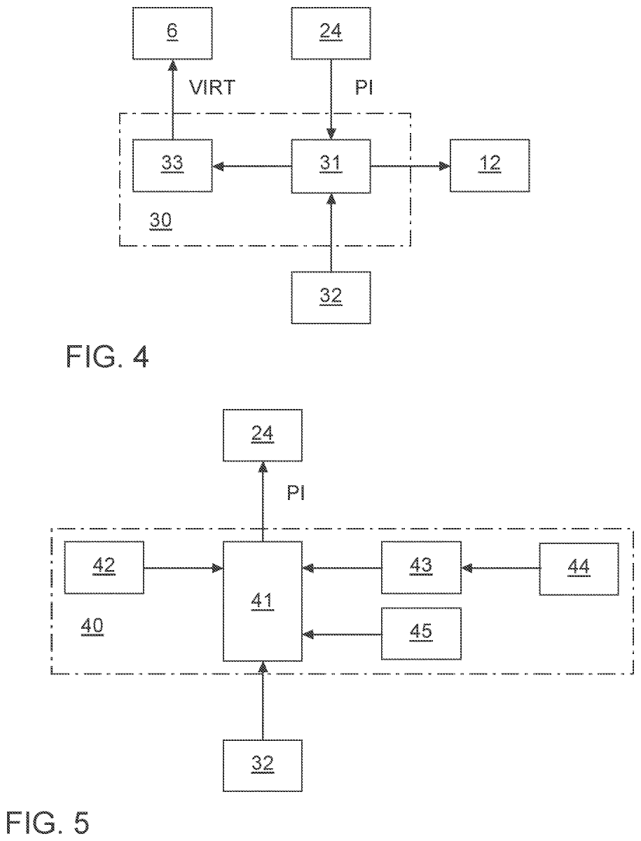

In an alternative embodiment, instead of the touchscreen 11 or in addition to the touchscreen 11, an operating element 3 may be provided by means of which correspond functions of the motor vehicle 100 may be operated in conjunction with information depicted by means of the display 12. The motor vehicle 100 is operated by means of the operating device 4 in a menu-guided manner. The operating elements that may be displayed by means of the display 12 in conjunction with the display control 10 are organized in a menu structure that comprises an operating mask for the infotainment system 20, an operating mask for the automatic climate control 21, an operating mask for the navigation system 22, and an operating mask for the telephone 23. To operate the motor vehicle 100, it also comprises a voice operating device 26 that comprises a microphone, a speaker as well as an evaluation for recognizing voice commands. The infotainment system 20, the automatic climate control 21, the navigation system 22, the telephone 23, the voice control device 26, as well as the display control 10 are data-linked to each other via the bus system 25. Moreover a vehicle controller 27, a parking space display module 30 (see FIG. 4), and a parking space recognition module 40 (see FIG. 5) are connected to the bus system 25. The display control 10 moreover serves to control a head-up display HUD 6 in the windshield of the vehicle.

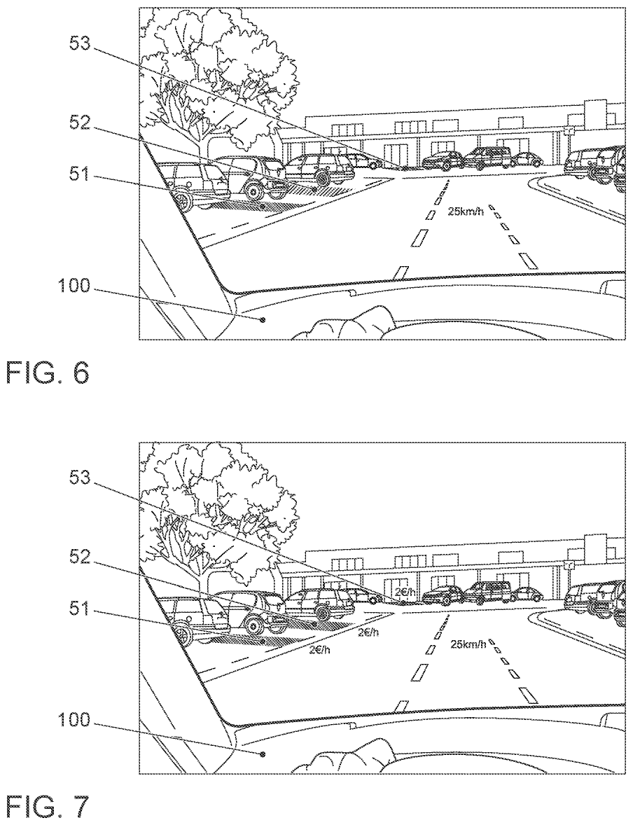

The parking space display module 30 enters parking space information PI via the communication interface 24 such as positions and if applicable the associated size of parking spaces (as well as if applicable other characteristics such as fees). By using the transmitted positions of the parking spaces and the initial value from a positioning module 32, a tracking module 31 ascertains the orientation and position of the vehicle 100 relative to a recognized parking space. From the initial value from the tracking module 31, an image generator 33 ascertains a virtual image component VIRT for identifying parking spaces by means of the HUD 6. To accomplish this, the virtual component VIRT is depicted by means of the HUD 6 as for example shown in FIG. 6 and FIG. 7. It may be provided that, by means of the display 12, an overview of parking spaces is depicted that is less detailed but contrastingly offers a larger preview. For example parking spaces on roads in the normal map display of a navigation system are identified by color in order to indicate parking spaces.

The motor vehicle 100 receives the information on parking spaces via its communication interface 24 by means of a car-2-car communication link 102 from another motor vehicle 200, or via a wireless communication link 311 from a center 300. In the latter case, motor vehicles 100, or respectively 200 forward the parking spaces that they recognize to the center 300 via corresponding communication links 311 and 312.

To accomplish this, the vehicle 100, in addition to the vehicle 200, has a parking space recognition module 40 as shown in detail in FIG. 5. Parking space recognition sensors 42 are provided in the motor vehicle 100 that output the parking space information PI on free parking spaces, or at least recognized free parking spaces, to a link module 41 that links the information on free parking spaces to a signal of the positioning module 32 (which may be part of the navigation system 22) so that the parking spaces that have been recognized by means of the parking space recognition sensors 42 are assigned a position. Optionally, the parking space recognition module 42 also comprises a camera 44 and an evaluation module 43 assigned to the camera 44 for evaluating the image signal supplied by the camera 44. The evaluation module 43 serves to recognize signs that signal no parking, or respectively no stopping, and an assumed parking space that was recognized as such by the parking space recognition sensors 42 is therefore not evaluated as such. It may be provided that the evaluation module 43 recognizes no stopping signs, no parking signs, exits, restricted areas and disabled parking spaces. If the evaluation module 43 does not yield anything to the contrary with respect to a parking space recognized by the parking space recognition sensors 42, the link module 41 assigns location data to the parking space recognized by the parking space recognition sensors 42, and transmits the parking space to the center 300 by the communication interface 24 via the communication link 311, and/or if a car-2-car link is provided, by the communication link 102 to the vehicle 200. Beneficially, a memory 45 is archived in which parking spaces are saved so that only free spaces are reported as free parking spaces that are archived as parking spaces in the memory 45.

FIG. 6 and FIG. 7 show exemplary embodiments of the AR-based identification of parking spaces 51, 52, 53. The size of the parking spaces may for example be indicated by a colored border (such as red, yellow, green).

### LIST OF REFERENCE NUMERALS

1 Group of motor vehicles
2 Steering wheel
3 Operating element
4 Operating device
5 Dashboard
6 HUD (display in the windshield)
10 Display control
11 Touchscreen
12 Display
13 Actuator
20 Infotainment system
21 Automatic climate control
22 Navigation system
23 Telephone
24 Communication interface
25 Bus system
26 Voice control device
27 Vehicle controller
30 Parking space display module
31 Tracking module
32 Positioning module
33 Image generator
40 Parking space recognition module
41 Link module
42 Parking space recognition sensors
43 Evaluation
44 Camera
45 Memory
51, 52, 53 Parking space
100 Motor vehicle
200 Motor vehicle
300 Center
102 Communication link
312 Communication link
311 Communication link
VIRT Virtual image component
PI Parking space information

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “serving as an example, instance, or exemplification”.

The mere fact that certain measures are recited in mutually different dependent claims or embodiments does not indicate that a combination of these measures cannot be used to advantage. Any reference signs in the claims should not be construed as limiting the scope.

What is claimed is:

1. A motor vehicle with a positioning circuit for determining the position of the motor vehicle, wherein the motor vehicle comprises a communication interface for receiving parking space information, wherein the parking space information comprises the position of the parking space, wherein the motor vehicle comprises a tracking circuit for determining the position of the parking space in relation to the position of the motor vehicle as well as an image generator for determining the position of a virtual image component characterizing a parking space on a transparent display depending on the position of the parking space in relation to the position of the motor vehicle.

2. The motor vehicle of claim 1, wherein the transparent display is arranged in the windshield of the motor vehicle.

3. The motor vehicle of claim 1, wherein the transparent display is arranged in data glasses, wherein the data glasses are data-linked to the motor vehicle.

4. The motor vehicle of claim 1, wherein comprises environmental sensors for the motor vehicle comprises environmental sensors for detecting parking space information.

5. The motor vehicle of claim 4, wherein detected parking space information is output via the communication interface.

6. A communication system for motor vehicles, wherein the communication system has a motor vehicle of claim 1, wherein the communication system also has at least one additional motor vehicle for providing the parking space information.

7. The communication system for a motor vehicle of claim 6, wherein the communication system comprises a wireless communication link directly or indirectly between the motor vehicle and the other motor vehicle for transmitting parking space information from the other motor vehicle to the motor vehicle.

8. The motor vehicle of claim 1, wherein the parking space information comprises the position of the parking space and the size of the parking space.

9. The motor vehicle of claim 2, wherein the motor vehicle comprises environmental sensors for detecting parking space information.

10. The motor vehicle of claim 3, wherein the motor vehicle comprises environmental sensors for detecting parking space information.

11. The motor vehicle of claim 9, wherein detected parking space information is output via the communication interface.

12. The motor vehicle of claim 10, wherein detected parking space information is output via the communication interface.
